(19) United States
(12) Patent Application Publication
(10) Pub. No.: US 2007/0269632 A1
(43) Pub. Date: Nov. 22, 2007

(54) Sound Absorbing Material

(76) Inventors: Yoshihiko Ota, Shizuoka-ken (JP); Hiroki Sato, Shizuoka-ken (JP)

Correspondence Address: Muramatsu & Associates, Suite 310, 114 Pacifica, Irvine, CA, 92618, US

(21) Appl. No.: 10/580,773

(22) PCT Filed: Nov. 27, 2003
(86) PCT No.: PCT/JP03/15143

§ 371 Date: Feb. 21, 2007

(51) Int. Cl. G01K 11/16; B23B 5/26

(52) U.S. Cl. 428/98; 442/370

(57) ABSTRACT

A sound absorbing material (10) including cover sheets (30) superimposing on both surfaces of a base sheet (20) and fixed thereto by thermoforming (suitable fixing means) (51), wherein the base sheet (20) is made of a non-woven fabric composed of extra fine fibers which are manufactured by a melt blown method, and each cover sheet (30) is made of a non-woven fabric composed of long fibers, the base sheet (20) and the cover sheets (30) being superimposed in their non-adhering states.

### BACKGROUND OF THE INVENTION

1. Field of the Invention

This invention relates to a sheet-like sound absorbing material which can be used in those parts where efficient sound absorbing effects are required, such as gasoline tank covers for transportation equipments, covers for air conditioning equipments, coating material for the inner wall of bonnets, and the like.

2. Related Art

As a sound absorbing material of this type, there have been known a conventional example 1, which is made of a non-woven fabric which is integrally composed of extra fine fibers of polypropylene having an average diameter of about 2 micro meters manufactured by a melt blown method and short fibers of polyester having an average diameter of about 25 micro meters, this being adapted to provide thickness, and a conventional example 2, which is made of long filers of polyester. Both of those conventional examples 1, 2 exhibit favorable sound absorbing effects but improvements are still required.

The present invention has been accomplished in view of the above.

### SUMMARY OF THE INVENTION

It is, therefore, a primary object of the invention to provide a sound absorbing material which is capable of offering a better sound absorbing effect than the conventional sound absorbing materials.

To achieve the above object, the present inventor carried out an extensive search and development and accomplished the present invention. According to the present invention, there is provided a sound absorbing material including cover sheets superimposing on both surfaces of a base sheet and fixed thereto by suitable fixing means, wherein the base sheet is made of a non-woven fabric composed of extra fine fibers which are manufactured by a melt blown method, and each cover sheet is made of a non-woven fabric composed of long fibers, the base sheet and the cover sheets being superimposed in their non-adhering states. Accordingly, as shown in the graph 2, the sound absorbing effect is synergistically improved compared with the above-mentioned conventional sound absorbing materials.

Thus, use value of this sound absorbing material is more increased than that of the conventional ones and in addition, the range of use of this sound absorbing material is enlarged.

It is preferable that the base sheet is made of a non-woven fabric (conventional example 1) integrally composed of extra fine fibers of polypropylene having an average diameter of about 2 micro meters which are manufactured by a melt blown method and short fibers of polyester having a average diameter of about 25 micro meters, this being adapted to provide thickness, and the cover sheet is made of a non-woven fabric (conventional example 2) which is composed of long fibers of polyester. According to this arrangement, the sound absorbing material according to the present invention can more easily be manufactured.

### BRIEF DESCRIPTION OF THE DRAWINGS

FIG. 1 is a sectional view of a sound absorbing material according to one embodiment of the present invention.

FIG. 2 is a graph showing the sound absorbing effect of the above sound absorbing material.

### BEST MODE FOR CARRYING OUT THE INVENTION

In order to explain the present invention in more detail, the present invention will hereinafter be described in the form of one embodiment with reference to the accompanying drawings.

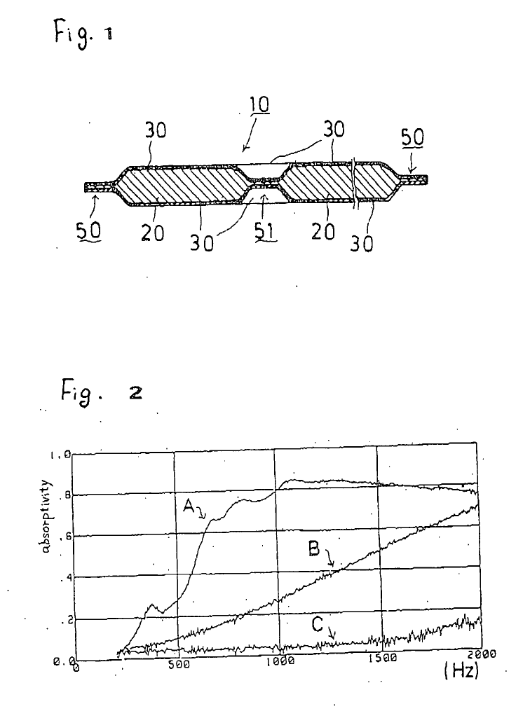

In FIG. 1, reference numeral 10 denotes a sound absorbing material according to one embodiment of the present invention, and 20, a base sheet thereof, respectively. The base sheet 20 is, as previously described, made of a non-woven fabric integrally composed of extra fine fibers of polypropylene having an average diameter of about 2 micro meters manufactured by a melt blown method and short fibers of polyester having an average diameter of about 25 micro millimeters, this being adapted to provide thickness. Since this non-woven fabric has a large quantity of air layer among the fine fibers, elasticity is good.

The physical properties of the non-woven fabric composing this base sheet 10 are as follows and the indications in the respective parenthesis show testing conditions). In case of a thickness of 10 mm (measured under a load of 0.002 psi), the weight is 200 g/m², the water content is 0.4% (JIS L3203), heat conductivity (0.0342 W/mK) (ASTM C518 and JIS A1412, Rapid K manufactured by Holemetrix is used) (average temperature: 22.5 degrees C.), heat resistance: 120 degrees C., the sound absorption is non-changed after 2000 hours (measured in accordance with ASTM E 1050), the tensile strength is vertical: 9.3 N (0.95 kgf), horizontal: 10.0 N (1.02 kgf (sample piece width: 50 MM, clamping interval: 200 mm, tensile speed: 200 mm/min), flame retardancy corresponds to FMVSS No. 302, and composition is polypropylene: 65%, polyester: 35%. The non-woven fabric composing this base sheet 20 corresponds to the so-called conventional example 1. As one example, there exists Thinsulate (trade mark) manufactured by Sumitomo 3M Limited.

Next, reference numerals 30, 30 denote cover sheets. Those cover sheets 30, 30 are superimposed on both surfaces of the base sheet 20 in their non-adhering states. This cover sheet 30 is made of a non-woven fabric formed of long fibers of polyester and having a thickness of about 0.2 to 0.3 mm and having flexibility.

The physical properties (indicated in the parenthesis) of the non-woven fabric which composes this cover sheet 120 are as follows. The measuring method is in accordance with JIS L1906. However, the chuck interval 100, the thickness of the sample: 0.28 mm and the tensile test conditions are as indicated.

(1) tensile strength (N/5 cm)

| | |
|---|---|
| vertical | 205 |
| horizontal | 80 |

(2) elongation (%)

| | |
|---|---|
| vertical | 40 |
| horizontal | 35 |

(3) tear strength (N) (according to the pendulum method)

| | |
|---|---|
| vertical | 9.2 |

Also, its chief composition includes polyester (polyethylene terephthalate, modified polyester) and a small amount of carbon block and titanium oxide as a coloring material. No adhesive agent nor finishing oil solution is used. The non-woven fabric which composes this cover sheet 30 corresponds to the so-called conventional example 2, and there exists SPUNBOND (Registered Trade Mark) manufactured by Unitika Ltd.

The cover sheets 30, 30 are thermoformed (corresponding to the “suitable fixing means” of the present invention) to the both surfaces of the base sheet 20 in their non-adhering states under the conditions of press internal heat source temperature being set to 120 degrees C. at the upper surface and 130 degrees C. at the lower surface, the mold temperature being kept at 110 degrees C., the press pressure being set to 3 to 10 kgf/cm² and the pressing time being set to 6 to 8 sec. It is also accepted that a press-bonding part 51 is arranged in a spot manner and a cross-like cut passing through an attachment part is disposed at this part.

In FIG. 2, a folding line A indicates a sound absorption according to this embodiment, a folding line B indicates a sound absorption of a sound absorbing material according to the conventional example 1, and a folding line C indicates a sound absorption of a sound absorbing material (superimposed state of two sheets) according to the conventional example 2. The measuring instrument used is of a vertical incidence type and the measuring temperature is 27 degrees C. The size of the sample is 90φ.

As apparent from this graph, the sound absorption of the sound absorbing material 10 according to the present invention is not merely to plus the sound absorption of the conventional example 1 to the sound absorption of the conventional example 2 (superimposed state of two sheets) but it shows a significant excellent sound absorption at about 300 Hz to 1800 Hz. Particularly, it shows an outstanding sound absorption at 600 Hz to 1600 Hz.

### INDUSTRIAL APPLICABILITY

As described hereinbefore, the sound absorbing material according to the present invention is superior in sound absorbing effect to the conventional one and therefore, can effectively be utilized in those parts where efficient sound absorbing effects are required, such as gasoline tank covers for transportation equipments, covers for air conditioning equipments, coating material for the inner wall of bonnets, and the like.

What is claimed is:

1. A sound absorbing material including cover sheets superimposing on both surfaces of a base sheet and fixed thereto by suitable fixing means, wherein said base sheet is made of a non-woven fabric composed of extra fine fibers which are manufactured by a melt blown method, and each cover sheet is made of a non-woven fabric composed of long fibers, said base sheet and said cover sheets being superimposed in their non-adhering states.

2. A sound absorbing material according to claim 1, wherein said base sheet is made of a non-woven fabric integrally composed of extra fine fibers of polypropylene having an average diameter of about 2 micro meters which are manufactured by a melt blown method and short fibers of polyester having a average diameter of about 25 micro meters, this being adapted to provide thickness, and said cover sheet is made of a non-woven fabric which is composed of long fibers of polyester.
